(19) United States
(12) Patent Application Publication
(10) Pub. No.: US 2006/0166678 A1
(43) Pub. Date: Jul. 27, 2006

(54) Profile selection and call forwarding based upon wireless terminal GPS location coordinates

(76) Inventors: Jeyhan Karaoguz, Irvine, CA (US); James D. Bennett, San Clemente, CA (US)

Correspondence Address: GARLICK HARRISON & MARKISON LLP, P.O. BOX 160727, AUSTIN, TX, 78716-0727, US

(21) Appl. No.: 11/069,468

(22) Filed: Mar. 1, 2005

Related U.S. Application Data
(60) Provisional application No. 60/647,090, filed on Jan. 26, 2005.

(51) Int. Cl. H04Q 7/20

(52) U.S. Cl. 455/456.1

(57) ABSTRACT

A wireless terminal adjusts its profile settings based upon its GPS coordinates. The wireless terminal accesses its GPS receiver to determine its location coordinates, which may include elevation. The wireless terminal then accesses a plurality of location based profile rules, each of which includes location parameters and corresponding profile settings. The wireless terminal selects a location based profile rule of the plurality of location based profile rules based upon the location coordinates of the wireless terminal. The wireless terminal enacts corresponding profile settings of the selected location based profile rule. The profile settings may cause the wireless terminal to adjust its ringer on/off settings, its ringer volume settings, the number of rings it provides in response to an incoming communication, the ringer cadence, the number of repeat rings for incoming communications, vibration settings, call filtering settings, call forwarding settings, or message receipt settings, for example.

### CROSS REFERENCE TO RELATED APPLICATION

This application claims priority to U.S. Provisional Patent Application Ser. No. 60/647,090, filed Jan. 26, 2005, which is incorporated herein by reference for all purposes.

### BACKGROUND

1. Field of the Invention

The present invention relates generally to wireless communications; and more particularly to the operation of a wireless terminal.

2. Background of the Invention

Communication systems are well known. Communication systems include both wired communication systems and wireless communication systems. Wired communication systems include the Public Switched Telephone Network (PSTN), Wide Area Networks (WANs), Local Area Networks (LANs), and other networks that use wired or optical media for the transmission of data. Wireless communication systems include cellular telephone systems, satellite communication systems, Wireless Local Area Networks (WLANs), Wireless Wide Area Networks (WWANs), Wireless Personal Area Networks (WPANs), and other networks that employ a wireless link between a serviced terminal and a network infrastructure. Of course, many communications are serviced using a combination of wireless communication systems and wired communication systems.

Wireless communication systems support mobility of serviced wireless terminals. In cellular wireless communication systems, a cellular telephone may roam across wide areas and still receive service. In the United States, many service providers support nationwide roaming of cellular telephones. Such is also the case in Europe and other countries across the globe. WLAN service areas are typically serviced by one or more Wireless Access Points (WAPs) and a backbone network. WLANs typically service a premises such as an office complex, a coffee shop, an airport lounge, a home, etc. Wireless terminals may roam from WLAN service area to WLAN service area. WPANs typically service communications between wireless devices at a maximum distance of 10 feet. WPAN wireless terminals typically have the ability to establish WPAN communications with any proximate servicing host/peer device.

As is generally known, cellular telephones and other wireless terminals may support multiple profiles. Each of these profiles may have particular ringer settings, vibration settings, call termination options, and other phone settings. When a user of the cellular telephone or wireless terminal operates the device outside, he or she may desire a higher ring volume. When the user of the wireless terminal is attending a meeting, the user often desires that the cellular telephone not ring so as disturb the meeting. Profiles and other phone settings must be manually altered by the user. Profiles and other phone settings typically provide only a limited benefit. Thus, there is a need in the art for a wireless terminal that supports improved profile operations.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a wireless communication system that services a wireless terminal operating according to the present invention;

FIG. 2 is a flow chart illustrating operation according to an embodiment of the present invention;

FIG. 3 is a flow chart illustrating various profile setting adjustments according to embodiments of the present invention;

FIG. 4 is a flow chart illustrating operation according to one aspect of the present invention;

FIG. 5 is a block diagram illustrating a wireless terminal constructed and operating according to the present invention; and

FIG. 6 is a block diagram illustrating a system that may be used to create location based profile rules according to the present invention.

### DETAILED DESCRIPTION OF THE DRAWINGS

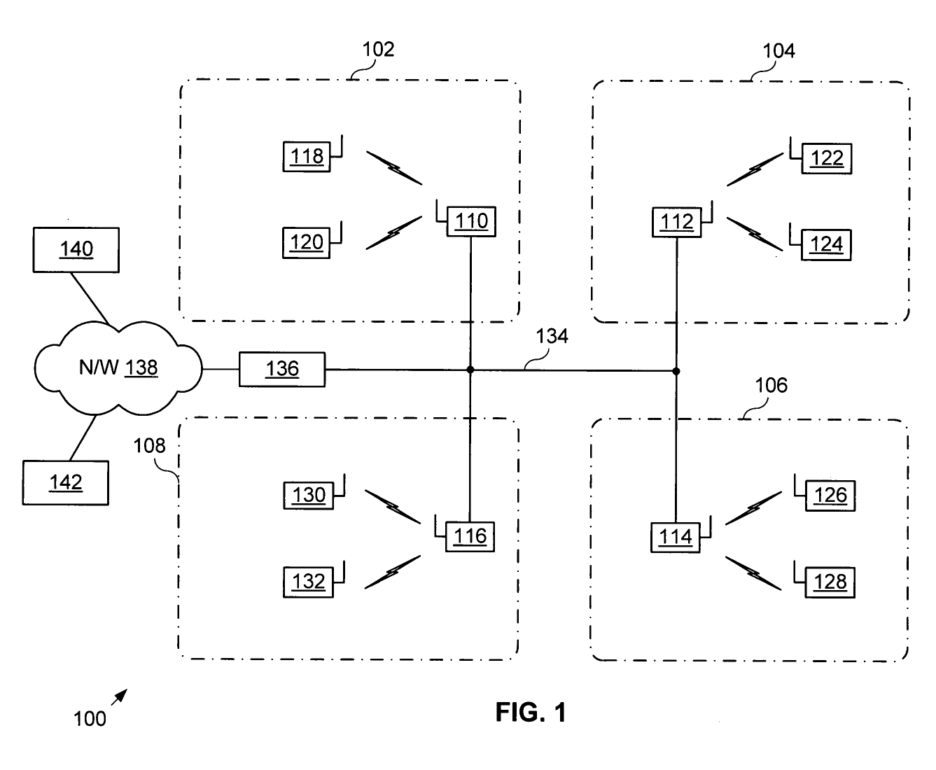

FIG. 1 is a system diagram illustrating a wireless communication system that services a wireless terminal operating according to the present invention. The wireless communication system 100 of FIG. 1 shows diagrammatically location areas 102, 104, 106, and 108. Each of these location areas 102-108 may correspond to a traffic pattern of the wireless terminal. For example, location area 102 may correspond to an office building in which a user of the wireless terminal works. Likewise, location area 104 may correspond to the user's home. Further, location area 106 may correspond to one or more locations that the user frequents during working hours. Finally, location area 108 may correspond to an area or location that the user frequents during non-working times, e.g., a church, a local bar, restaurants, or another location that the user frequents while not working. Each of the location areas 102-108 includes one or more servicing base stations or wireless access points (WAPs). For example, location area 102 is serviced by base station/WAP 110. Likewise, location area 104 is serviced by base station/WAP 112, location area 106 is serviced by base station/WAP 114, and location area 108 is serviced by base station/WAP 116. The reader should understand that the structure of FIG. 1 is used only to convey the principles of the present invention and it is not intended to be a detailed description of a cellular wireless communication system, a Wireless Local Area Network (WAN), a Wireless Wide Area Network (WWAN), or a Wireless Personal Area Network (WPAN).

As is shown, base station/WAP 110 supports wireless terminals 118 and 120 when operating within location area 102. Likewise, base station/WAP 112 supports wireless terminals 122 and 124 when operating within location area 104. Further, base station/WAP 114 supports wireless terminals 126 and 128 when operating within location area 106. Finally, base station/WAP 116 supports wireless terminals 130 and 132 when operating within location area 108. The base station/WAPs 110, 112, 114, and 116 are serviced via network backbone 134 and interface device 136. The interface device 136 couples the backbone network 134 to another network 138. The other network 138 may include a Local Area Network (LAN), a Wide Area Network (WAN), the Internet, or any other type of network that couples the network backbone 134 via the network interface 136 to computers or terminals 140 and 142.

According to the present invention, each wireless terminal 118-132 may operate to automatically alter its profile based upon its location coordinates. Operation according to the present invention commences with a wireless terminal, e.g., 118, accessing its GPS receiver to determine its location coordinates, which may include an elevation of the wireless terminal 118. The wireless terminal 118 then accesses a plurality of location based profile rules. Each location based profile rule of the plurality of location based profiles rules includes location parameters and corresponding profile settings. The wireless terminal 118 selects a location based profile rule of the plurality of location based profile rules based upon the location coordinates, which may include the elevation of the wireless terminal 118. Optionally, the time of day, date, day of week, and other additional information may be employed to select the location based profile rule. Then, the wireless terminal 118 enacts corresponding profile settings of the selected location based profile rule. The profile settings may cause the wireless terminal 118 to adjust its ringer on/off settings, its ringer volume settings, the number of rings it provides in response to an incoming communication, the ringer cadence, or the number of repeat rings for incoming communications. Alternately, the profile settings may adjust vibration settings, call filtering settings, call forwarding settings, or message receipt settings, for example.

According to one aspect of the present invention, the location parameters of the location based profile rules may define a geographical boundary. The geographical boundary may be a workplace boundary, a room boundary, a boundary of a group of rooms, a boundary of a floor of a building, or a residence boundary, for example. Further, the geographical boundary may be a school boundary, a theatre boundary, or a stadium boundary, for example. According to this aspect, the boundaries of each location area 102-106 may correspond to the location parameters of a corresponding location based profile rule. In such case, when wireless terminal 122 enters location area 104 that corresponds to the user's home, the wireless terminal 122 enacts a corresponding profile. When wireless terminal 118 enters an office building in which a user of the wireless terminal works and that corresponds to location area 102, the wireless terminal 118 enacts corresponding profile rules. Further, when a wireless terminal resides within a geographical area corresponding to none of its plurality of location based profile rules location parameters, the wireless terminal may implement default profile settings.

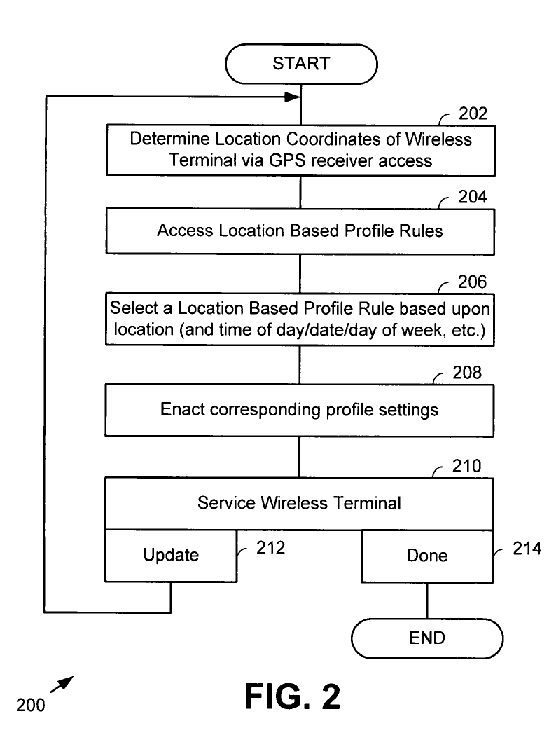

FIG. 2 is a flow chart illustrating operation according to an embodiment of the present invention. The operations 200 of FIG. 2 commence with the wireless terminal accessing its GPS receiver to determine its location coordinates (Step 202). The location coordinates may include an elevation of the wireless terminal. The wireless terminal then accesses a plurality of location based profile rules (Step 204). Each location based profile rule of the plurality of the location based profile rules includes location parameters and corresponding profile settings. The wireless terminal then selects a location based profile rule of the plurality of the location based profile rules based upon location coordinates of the wireless terminal, which may include the elevation of the wireless terminal (Step 206). Optionally, the time of day, date, day of week, and other additional information may be employed to select the location based profile rule at step 206. The wireless terminal then enacts the corresponding profile settings (Step 208). The wireless terminal then services communications and performs other of its operations (Step 210).

Periodically, or based upon a detected change in the location of the wireless terminal, the wireless terminal determines that update of the profile may be required (Step 212). From Step 212, operation returns to Step 202 where the location coordinates of the wireless terminal are again determined. Of course, the operations of Step 212 may be performed in conjunction with access to the GPS receiver to determine when the wireless terminal has moved physically from its current location to such degree that update of the profile settings may be required. Operation from Step 210 may further include completing (Step 214). In such case, operation 200 ends.

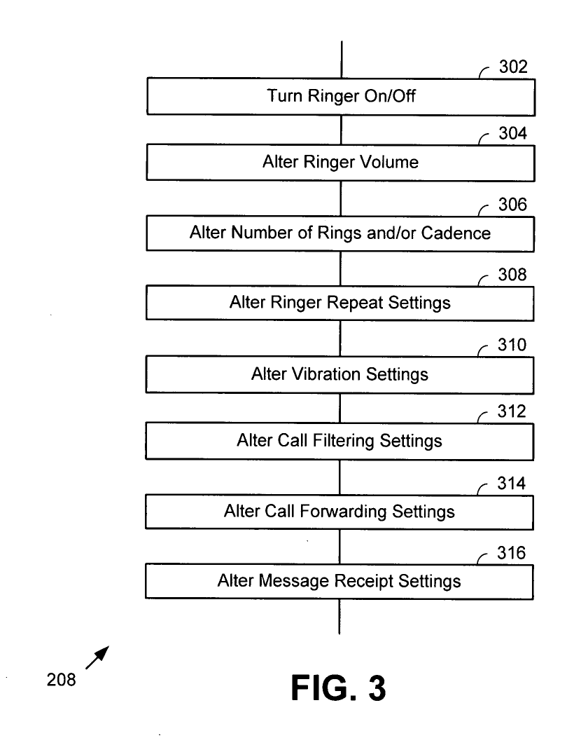

FIG. 3 is a flow chart illustrating various profile setting adjustments according to embodiments of the present invention. The alterations to the profile settings illustrated in FIG. 3 may be performed singularly, in combination, or fully, depending upon the particular operation of the present invention. The operations 302-316 illustrated in FIG. 3 are shown simply to provide examples of profile setting alterations that may be performed according to the present invention and may be performed at step 208 of FIG. 2. Other profile settings and alternations may also be enacted without departing from the spirit and scope of the present invention.

As a first profile setting, alteration may include turning the wireless terminal's ringer on or off (Step 302). Further, changing profile settings may include altering the ringer volume of the wireless terminal (Step 304). Altering profile settings may include altering a number of rings that the wireless terminal provides upon receipt of incoming communications (Step 306). The number of rings may differ based upon the type of incoming communication. For example, an incoming voice call may cause the wireless terminal to ring a first number of times while an incoming voicemail message may cause the wireless terminal to ring a second number of times. Further, an incoming short message or email may cause the wireless terminal to ring still a different number of times. Each of these types of communications may cause the wireless terminal to produce a differing ring cadence.

Altering the profile settings according to the present invention may cause the wireless terminal to alter its ringer repeat settings (Step 308). The number of repeat rings provided may be set based upon expected ambient noise. For example, when the wireless terminal is operating within a stadium, it would be desirable to alert the user a number of times for incoming voice calls so that the user will be able to detect the ringing. Such is the case because the ambient noise within a stadium typically increases and decreases over time. Altering the profile settings may also include altering the vibration settings of the wireless terminal (Step 310).

Additional alterations may include altering call filtering settings for the wireless terminal (Step 312). As the reader will appreciate, when a user of the wireless terminal is within an important meeting, he or she would desire to receive only particular types of communications or communications initiated by particular terminals. In such case, the user may select caller ID's or sources of incoming communications that will be delivered to the wireless terminal. Other communications would simply be ignored and no alert would be provided to the user of the wireless terminal. Further, similarly to the operations of Step 312, altering the profile settings may include altering the call forward settings of the wireless terminal (Step 314). When the user is in a highly sensitive meeting such as a business meeting with a board of directors, the user may desire that the wireless terminal will provide no alerts, including alerts of missed communications. Altering the call forwarding setting may cause incoming calls to be delivered directly to voicemail instead of resulting in an alert provided to the wireless terminal. Further, when the user moves to a different location having different location parameters, the wireless terminal would automatically adjust its operations such that calls would no longer be forwarded but would be terminated to the wireless terminal with the appropriate alert provided. Finally, in the example of FIG. 3, altering the profile settings may include altering message receipt settings of the wireless terminal (Step 316).

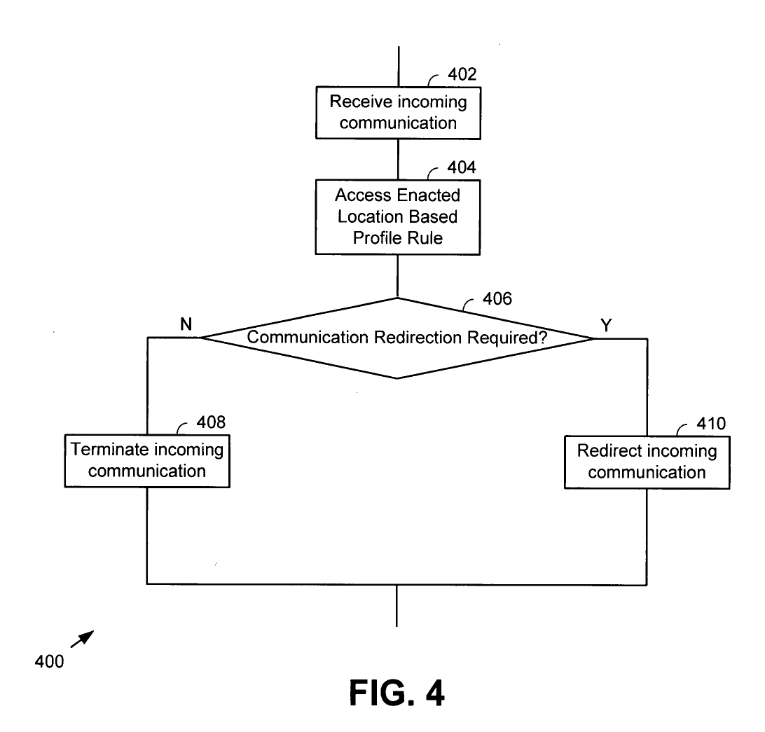

FIG. 4 is a flow chart illustrating operation according to one aspect of the present invention. The operations 400 of FIG. 4 may be enacted with Step 210 of FIG. 2. In such case, operation includes receiving an incoming communication by the wireless terminal (Step 402). The incoming communication may be an incoming voice call, an incoming message, an incoming email, or another type of incoming communication. Operation continues with the wireless terminal accessing the enacted location based profile rule (Step 404). Optionally, the time of day, date, day of week, and other additional information may be employed to select the location based profile rule used for call redirection operations. Then, the wireless terminal determines whether communication redirection is required (Step 406). If communication redirection is not required, the wireless terminal terminates the incoming communication and provides notification to the user via ringing, vibration, or other alert (Step 408). If communication redirection is required as determined at Step 406, the wireless terminal redirects the incoming communication (Step 410). In redirecting the incoming communication, the wireless terminal may send the incoming communication to voicemail, to a differing terminal, or to another destination that is designated either in the location based profile rule or otherwise.

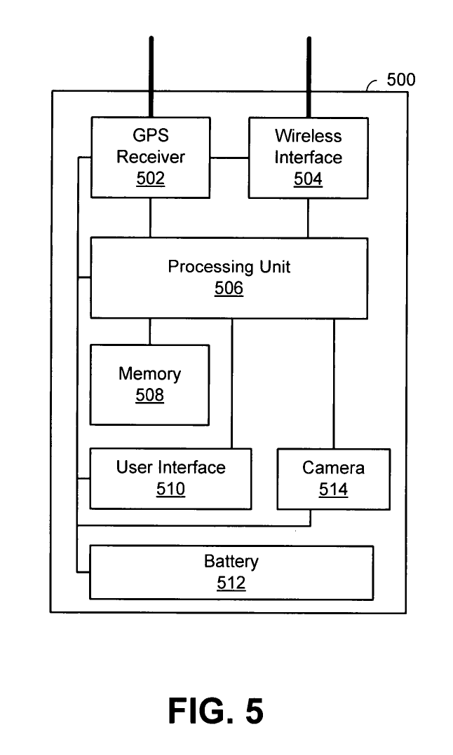

FIG. 5 is a block diagram illustrating a wireless terminal constructed according to the present invention. As shown in FIG. 5, the wireless terminal 500 includes a GPS receiver 502, a wireless interface 504, a processing unit 506, memory 508, user interface 510, and a battery 512. The components of the wireless terminal 500 are typically contained within a hard case that provides protection from the elements. The wireless terminal 500 may include a camera. The wireless interface 504 will have particular structure and functionality based upon the type of the wireless terminal 500. For example, when the wireless terminal 500 is a cellular telephone, the wireless interface 504 will support a corresponding interface standard e.g., GSM, GPRS, EDGE, UMTS, 1xRTT, 1xEV-DO, 1xEV-DV, etc. The wireless interface 504 of the cellular telephone 504 may also/alternately support WWAN, WLAN, and/or WPAN functionality. When the wireless terminal is a WLAN terminal for example, the wireless interface 504 will support standardized communication according to the IEEE 802.11x group of standards, for example. When the wireless terminal is a WPAN device, the wireless interface 504 would support the Bluetooth interface standard or another WPAN standard such as the IEEE 802.15 standard. In any case, the wireless interface 504 may support all or a subset of cellular telephone, WLAN, WWAN, and WPAN operations.

The processing unit 506 may include any type of processor such as a microprocessor, a digital signal processor, an Application Specific Integrated Circuit (ASIC), or a combination of processing type devices. The processing unit 506 is operable to execute a plurality of software instructions that are stored in memory 508 and downloaded for execution. The processing unit 506 may also include specialized hardware required to implement particular aspects of the present invention. Memory 508 may include SRAM, DRAM, PROM, flash RAM, a hard disk drive, an optical media drive, or any other type of memory capable of storing data and instructions.

A user interface 510 may include a microphone, a speaker, a keypad, a screen, a touch screen, a cursor control device, a light, a voice recognition system, an optical recognition system that would authenticate a user's iris, for example, and/or any other type of interface that may be employed in the wireless terminal. In some embodiments, the user interface 510 may include therewith ability to service a headset including a microphone and an earpiece for the user. In some embodiments of the wireless terminal 500, the user interface 510 is of reduced functionality to minimize the size of the wireless terminal 500. In such case, programming of the wireless terminal 500 may be performed via the wireless interface 504. In such case, the wireless terminal 500 may be small enough to be worn around a child's wrist, around the neck, pinned to the inside of clothing, placed in a pocket, or concealed upon the person. Battery 512 powers the components of the wireless terminal 500.

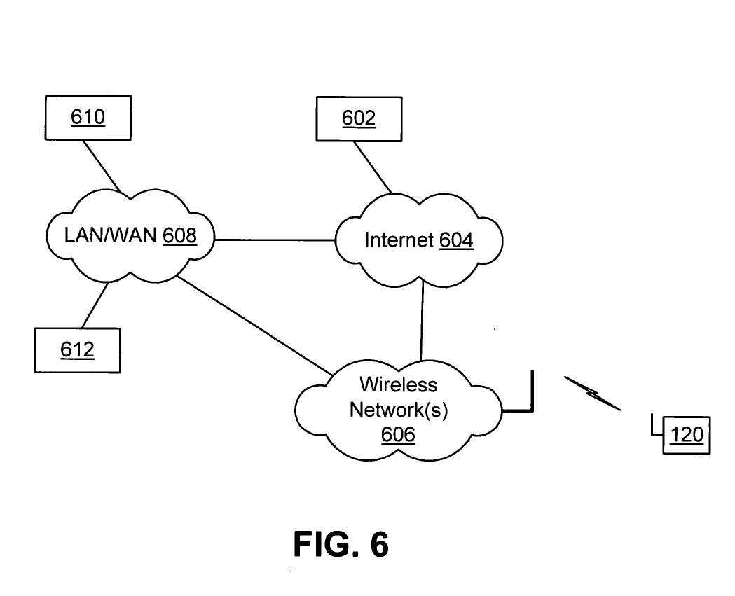

FIG. 6 is a block diagram illustrating a system that may be used to create location based profile rules according to the present invention. The components of FIG. 6 are illustrated to further describe how a user may establish a plurality of location based profile rules for a wireless terminal 120. The system of FIG. 6 includes a wireless network 606 that supports wireless communications with the wireless terminal 120. FIG. 6 also illustrates the Internet 602 and a LAN/WAN 608 that intercouples with the Internet 604 and the wireless network 606. A user of the wireless terminal may access a server computer 602 or 610 via a user terminal 612. The user terminal 612 may be a personal computer, laptop computer, or another type of device. According to an embodiment of the present invention, the user establishes a plurality of location based profile rules via interaction with a server computer 602 or 610. The user employs the client computer 612 to access the server computer 602 or 610 to establish the plurality of location based profile rules. Once this plurality location based profile rules are established, they may be downloaded to the wireless terminal 120 via the LAN/WAN 608, Internet 604, and the wireless network 606.

As one of average skill in the art will appreciate, the term “substantially” or “approximately,” as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the terms “communicatively coupled” or “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents, and alternatives falling within the spirit and scope of the present invention as defined by the claims.

1. A method for operating a wireless terminal comprising:
accessing a Global Positioning System (GPS) receiver of the wireless terminal to determine location coordinates of the wireless terminal;
accessing a plurality of location based profile rules, each location based profile rule of the plurality of location based profile rules including location parameters and corresponding profile settings;
selecting a location based profile rule of the plurality of location based profile rules based upon the location coordinates of the wireless terminal; and
enacting profile settings of the selected location based profile rule.

2. The method of claim 1, wherein the profile settings are selected from the group consisting of:
ringer off/on settings;
ringer volume settings;
number of ring settings;
ringer cadence settings;
ringer repeat settings;
vibration settings;
call filtering settings;
call forwarding settings; and
message receipt settings.

3. The method of claim 1, further comprising:
when a first location based profile rule having corresponding profile settings is selected, terminating an incoming communication; and
when a second location based profile rule having corresponding profile settings is selected, redirecting the incoming communication to an alternate destination.

4. The method of claim 1, wherein the wireless terminal comprises at least one of a cellular telephone, a Wireless Personal Area Network (WPAN) terminal, and a Wireless Local Area Network (WLAN) terminal.

5. The method of claim 1, further comprising receiving input to establish the plurality of location based profile rules.

6. The method of claim 5, further comprising:
the user establishing the plurality of location based profile rules via interaction with a server computer communicatively coupled to the wireless terminal; and
the server computer downloading the plurality of location based profile rules to the wireless terminal.

7. The method of claim 1, wherein the location parameters of a location based profile rule define a geographical boundary.

8. The method of claim 7, wherein the geographical boundary is selected from the group consisting of at least:
a workplace boundary;
a room boundary;
a boundary of a group of rooms;
a boundary of a floor of a building;
a residence boundary;
a school boundary;
a theatre boundary; and
a stadium boundary.

9. The method of claim 1:
wherein the location coordinates include an elevation of the wireless terminal; and
the location based profile rule of the plurality of location based profile rules is further selected based upon the elevation.

10. The method of claim 9, wherein the location coordinates correspond to a particular floor in a building.

11. The method of claim 1, wherein the location based profile rule is further selected based upon a current time.

12. The method of claim 1, wherein the location based profile rule is further selected based upon a current date.

13. The method of claim 1, wherein the location based profile rule is further selected based upon a current day of the week.

14. A wireless terminal comprising:
a wireless interface;
a Global Positioning System (GPS) receiver;
a user interface; and
a processing unit communicatively coupled to the wireless interface, to the GPS receiver, and to the user interface, wherein the processing unit is operable to:
access the GPS receiver to determine location coordinates of the wireless terminal;
access a plurality of location based profile rules, each location based profile rule of the plurality of location based profile rules including location parameters and corresponding profile settings;
select a location based profile rule of the plurality of location based profile rules based upon the location coordinates of the wireless terminal; and
enact profile settings of the selected location based profile rule.

15. The wireless terminal of claim 14, wherein the profile settings are selected from the group consisting of:
ringer off/on settings;
ringer volume settings;
number of ring settings;
ringer cadence settings;
ringer repeat settings;
vibration settings;
call filtering settings;
call forwarding settings; and
message receipt settings.

16. The wireless terminal of claim 14, wherein the processing unit is further operable to:
when a first location based profile rule having corresponding profile settings is selected, terminate an incoming communication; and
when a second location based profile rule having corresponding profile settings is selected, redirect the incoming communication to an alternate destination.

17. The wireless terminal of claim 14, wherein the wireless terminal comprises at least one of a cellular telephone, a Wireless Personal Area Network (WPAN) terminal, and a Wireless Local Area Network (WLAN) terminal.

18. The wireless terminal of claim 14, wherein the processing unit is further operable to receive input via the user interface to establish the plurality of location based profile rules.

19. The wireless terminal of claim 18, wherein the processing unit is further operable to establish the plurality of location based profile rules via interaction with a server computer communicatively coupled to the wireless terminal by downloading the plurality of location based profile rules from the server computer.

20. The wireless terminal of claim 14, wherein the location parameters of a location based profile rule define a geographical boundary.

21. The wireless terminal of claim 20, wherein the geographical boundary is selected from the group consisting of at least:
a workplace boundary;
a room boundary;
a boundary of a group of rooms;
a boundary of a floor of a building;
a residence boundary;
a school boundary;
a theatre boundary; and
a stadium boundary.

22. The wireless terminal of claim 14, wherein
the location coordinates include an elevation of the wireless terminal; and
the processing unit further selects the location based profile rule of the plurality of location based profile rules based upon the elevation.

23. The method of claim 22, wherein the location coordinates correspond to a particular floor in a building.

24. The wireless terminal of claim 14, wherein the location based profile rule is further selected based upon a current time.

25. The wireless terminal of claim 14, wherein the location based profile rule is further selected based upon a current date.

26. The wireless terminal of claim 14, wherein the location based profile rule is further selected based upon a current day of the week.
